(19) United States
(12) Patent Application Publication
(10) Pub. No.: US 2015/0345713 A1
(43) Pub. Date: Dec. 3, 2015

(54) ILLUMINATION LAMP

(71) Applicants: TZU-HUA CHEN, TAOYUAN COUNTY (TW); SHAO-SHOU CHEN, TAOYUAN COUNTY (TW)

(72) Inventors: TZU-HUA CHEN, TAOYUAN COUNTY (TW); SHAO-SHOU CHEN, TAOYUAN COUNTY (TW)

(21) Appl. No.: 14/288,678

(22) Filed: May 28, 2014

(51) Int. Cl. F21K 99/00; F21V 23/06; F21V 23/00; F21V 1/00

(52) U.S. Cl. CPC F21K 9/30; F21V 1/00; F21V 23/06; F21V 23/005; F21Y 2101/02

(57) ABSTRACT

An illumination lamp includes a lamp base, a lampshade, and electrical contacts. The lamp base is integrally formed of ceramics and has a control circuit and at least one LED element laid on its surface. The lampshade covers each LED element on the lamp base surface. The electrical contacts extend respectively and integrally from two ends of the lamp base. The control circuit is formed on the lamp base surface by high-temperature sintered silver chemically bonded to the ceramics and covers an external portion of each electrical contact such that the electrical contacts are in electrical conduction with the control circuit and the at least one LED element. Heat generated by the at least one LED element can be absorbed by the ceramic lamp base through the silver and dissipate rapidly. The illumination lamp features a simple structure with minimal components, a simplified manufacturing process, and low production costs.

### BACKGROUND OF THE INVENTION

1. Technical Field

The present invention relates to an illumination lamp and more particularly to an improved light-emitting diode (LED) illumination lamp. Even more particularly, the present invention relates to a new-generation illumination lamp with minimal parts, featuring structural simplicity, a streamlined production process, and consequently a reduction in the time and cost required for manufacture as compared with those of the prior art.

2. Description of Related Art

With the advancement of materials technology, lamps for illumination purposes have evolved from the conventional incandescent lamps and fluorescent lamps to today's LED illumination lamps, which use LEDs as the light source. In addition to such obvious advantages as small volumes, high energy efficiency, and long service lives, LED illumination lamps generate less heat and consume less electricity than incandescent lamps and are free of mercury, which is a typical material in fluorescent lamps and a potential cause of pollution. LED illumination lamps are made of non-toxic materials, are recyclable, and are hence more environmentally friendly than their forerunners.

As a low-voltage semiconductor product in terms of construction, LEDs cannot be driven directly by standard alternating-current power and require an additional circuit for controlling voltage and current supply. Therefore, LED illumination lamps must be provided therein with a control circuit in order to control the voltage polarities of LEDs and limit the electric current.

FIG. 5 and FIG. 6 are respectively an assembled perspective view and an exploded perspective view of a conventional LED illumination lamp 40 for use in a car. The illumination lamp 40 in the drawings includes a lamp base 41, a circuit board 42, a lampshade 44, and electrical contacts 45. One surface of the circuit board 42 is provided with LED elements 43 and an LED control circuit. Conductive wires 46 are provided on two lateral sides of the circuit board 42 respectively. The circuit board 42 is fixed to the lamp base 41. The lampshade 44 covers each LED element 43 on the surface of the circuit board 42. The electrical contacts 45 are fastened to the two lateral sides of the lamp base 41 and of the lampshade 44 respectively and are brought into electrical conduction with the control circuit and the LED elements 43 on the circuit board 42 by the conductive wires 46.

It can be known from FIG. 5 and FIG. 6 that the conventional LED illumination lamp 40 for use in a our must be provided therein with the circuit board 42, which is an essential component and is fixed to the lamp base 41. However, not only does the circuit board 42 add to the components of the illumination lamp 40, but also the additional soldering process of the conductive wires 46 complicates the production process and increases the production costs of the illumination lamp 40.

The conventional LED illumination lamp 40 for use in a car as shown in FIG. 5 and FIG. 6 is but one example. In fact, all LED illumination lamps require a circuit board to be installed therein and related conductive wires and electrical contacts to be soldered in place, regardless of the shapes, structures, and uses of the lamps. That is to say, all LED illumination lamps share the aforesaid problems.

### BRIEF SUMMARY OF THE INVENTION

In view of the above, the present invention provides an illumination lamp having a novel design for effectively solving the problems of the prior art.

The primary objective of the present invention is to provide a new-generation illumination lamp which has a simple structure composed of minimal components and which simplifies the manufacturing process required so that the time and cost of manufacture can be reduced as compared with those of the prior art.

To achieve the above objective, the present invention adopts the following technical means.

The illumination lamp of the present invention includes a lamp base, a lampshade, and electrical contacts.

The lamp base has a surface laid with a control circuit and at least one LED element.

The lampshade covers each LED element on the surface of the lamp base.

The electrical contacts each extend integrally from one of two ends of the lamp base.

The lamp base is integrally formed of a ceramic material.

The control circuit laid on the surface of the lamp base is formed on the surface of the lamp base by sintering silver at a high temperature and thereby bonding silver to the ceramic material chemically. The control circuit also covers an external portion of the electrical contact at each of the two ends of the lamp base, thereby bringing the electrical contacts into electrical conduction with the control circuit and the at least one LED element on the surface of the lamp base.

According to the foregoing structure and design, the illumination lamp of the present invention can rapidly dissipate the heat generated by the at least one LED element. More specifically, the ceramic lamp base can absorb the heat through the silver on the surface of the lamp base to accelerate heat dissipation. Moreover, there is no need to provide the lamp with an internal circuit board or additional metal electrical contacts which are traditionally required on two lateral sides of the lamp base. Compared with the prior art, the number of components of the illumination lamp is significantly reduced, and the structure of the illumination lamp is simpler. The process conventionally required for soldering conductive wires is also made unnecessary. Consequently, the manufacturing process is streamlined, and production costs can be lowered. The intended objective of the present invention is thus achieved.

### BRIEF DESCRIPTION OF THE SEVERAL VIEWS OF THE DRAWINGS

The above and other objectives and the structural details of the present invention will be best understood by referring to the following detailed description of some illustrative embodiments in conjunction with the accompanying drawings, in which:

FIG. 1 is an assembled perspective view of the illumination lamp in one embodiment of the present invention;

FIG. 2 is an exploded perspective view of the illumination lamp shown in FIG. 1;

FIG. 3 is an exploded perspective view of the illumination lamp in the second embodiment of the present invention;

FIG. 4 is an exploded perspective view of the illumination lamp in the third embodiment of the present invention;

FIG. 5 is an assembled perspective view of a conventional illumination lamp; and

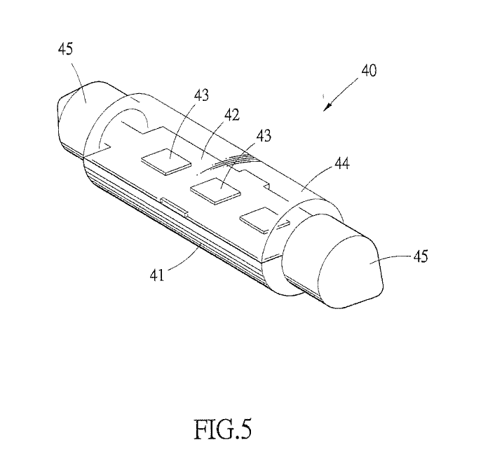

FIG. 6 is an exploded perspective view of the conventional illumination lamp shown in FIG. 5.

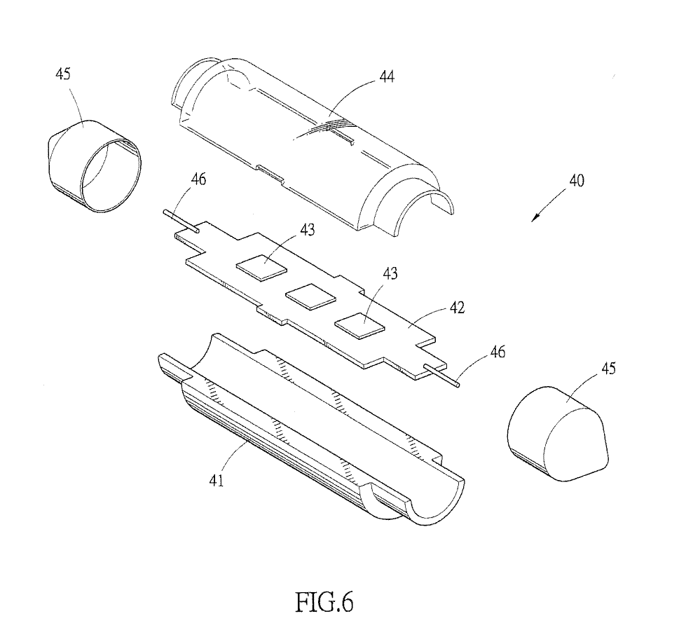

### DETAILED DESCRIPTION OF THE INVENTION

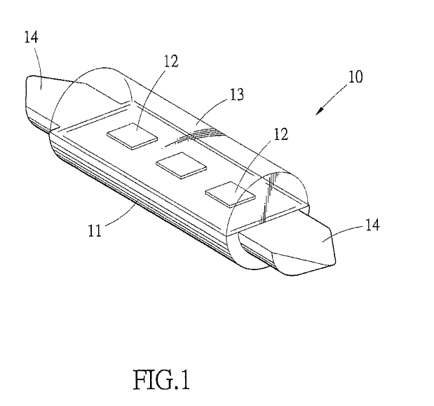

FIG. 1 is an assembled perspective view of the illumination lamp 10 in one embodiment of the present invention.

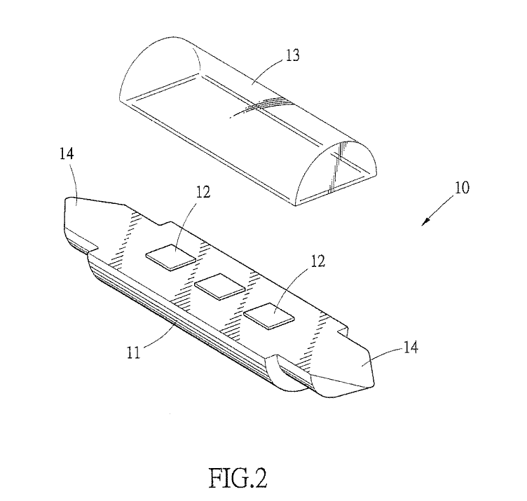

FIG. 2 is an exploded perspective view of the illumination lamp 10 shown in FIG. 1.

As shown in FIG. 1 and FIG. 2, the illumination lamp 10 of the present invention includes a lamp base 11, a lampshade 13, and electrical contacts 14.

One surface of the lamp base 11 is laid with a control circuit and at least one LED element 12.

The lampshade 13 covers each LED element 12 on the surface of the lamp base 11.

Each of the electrical contacts 14 extends integrally from one of the two opposite ends of the lamp base 11 and has a front end formed as a halved cone.

The lamp base 11 is integrally formed of a ceramic material.

The control circuit laid on the surface of the lamp base 11 is formed on the surface of the lamp base 11 by a sintering process in which silver is sintered at a high temperature and thereby chemically bonded to the ceramic material. The control circuit also covers an external portion of the electrical contact 14 at each of the two ends of the lamp base 11 such that the electrical contacts 14 are in electrical conduction with the control circuit and the LED elements 12 on the surface of the lamp base 11.

In the embodiment shown in FIG. 1 and FIG. 2, the heat generated by the LED elements 12 can be absorbed by the ceramic lamp base 11 via the silver (control circuit) laid on the surface of the lamp base 11 and thus dissipate rapidly. There is no need to provide the lamp base 11 with an additional circuit board and therefore no need to solder the conductive wires of such a circuit board. Compared with the prior art, not only is the number of components of the illumination lamp 10 reduced, but also the manufacturing process is simplified.

As mentioned above, the external portions of the electrical contacts 14 respectively and integrally extending from the two ends of the lamp base 11 are also covered with high-temperature sintered silver, which is formed on the outer surface of, and chemically bonded to the ceramic material of, each electrical contact 14. Therefore, the electrical contacts 14 do not require additional metal parts and can dispense with the soldering process otherwise needed to bring the electrical contacts 14 into electrical conduction with the control circuit. As a result, the illumination lamp 10 has fewer components and can be manufactured with a simpler process and at lower costs in comparison with its prior art counterparts.

In practice, the lamp base 11 may have two or more working surfaces to meet circuit requirements, and the control circuit may be laid on different working surfaces.

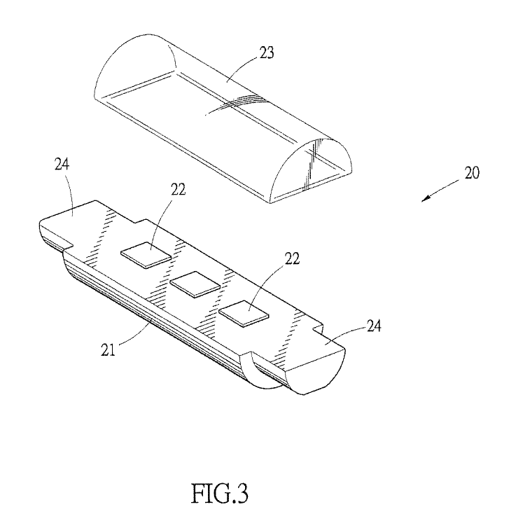

FIG. 3 is an exploded perspective view of the illumination lamp in the second embodiment of the present invention.

In the second embodiment shown in FIG. 3, the illumination lamp 20 includes a lamp base 21, a lampshade 23, and electrical contacts 24.

One surface of the lamp base 21 is provided with at least one LED element 22 and is laid with a control circuit.

The lampshade 23 covers each LED element 22 on the surface of the lamp base 21.

The electrical contacts 24 extend respectively and integrally from the two opposite ends of the lamp base 21.

The lamp base 21 is integrally formed of a ceramic material.

The control circuit laid on the surface of the lamp base 21 is formed on the surface of the lamp base 21 by sintering silver at a high temperature and thereby bonding silver chemically to the ceramic material. The control circuit also covers an external portion of the electrical contact 24 at each of the two ends of the lamp base 21 such that the electrical contacts 24 are in electrical conduction with the control circuit and the LED elements 22 on the surface of the lamp base 21.

In this embodiment, the front end of each electrical contact 24 is formed as a perpendicular plane, thus allowing the illumination lamp 20 to be installed in clamping holders of different configurations.

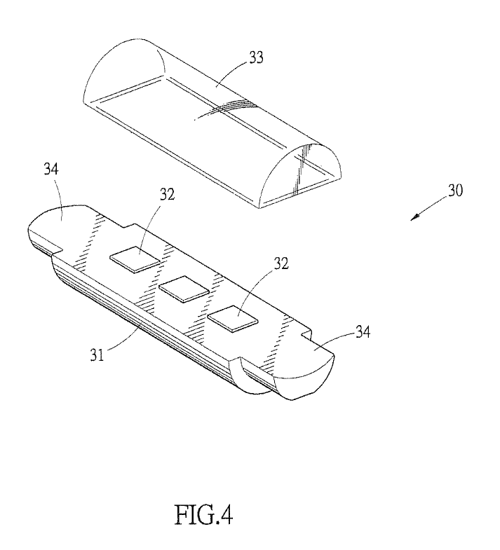

FIG. 4 is an exploded perspective view of the illumination lamp in the third embodiment of the present invention.

In the third embodiment shown in FIG. 4, the illumination lamp 30 includes a lamp base 31, a lampshade 33, and electrical contacts 34.

One surface of the lamp base 31 is provided with at least one LED element 32 and is laid with a control circuit.

The lampshade 33 covers each LED element 32 on the surface of the lamp base 31.

The electrical contacts 34 extend respectively and integrally from the two opposite ends of the lamp base 31.

The lamp base 31 is integrally formed of a ceramic material.

The control circuit laid on the surface of the lamp base 31 is formed on the surface of the lamp base 31 by sintering silver at a high temperature and thereby bonding silver chemically to the ceramic material. The control circuit also covers an external portion of the electrical contact 34 at each of the two ends of the lamp base 31 such that the electrical contacts 34 are in electrical conduction with the control circuit and the LED elements 32 on the surface of the lamp base 31.

In this embodiment, the front end of each electrical contact 34 is formed as a curved projection, thus allowing the illumination lamp 30 to be installed in clamping holders of different configurations.

The illumination lamps illustrated in FIG. 1 to FIG. 4 are but different embodiments of the present invention. In manufacture, the components of the illumination lamp of the present invention may vary in structure and shape from those in the foregoing embodiments but are still capable of achieving the intended objective, i.e., to dissipate heat rapidly, to dispense with the circuit board conventionally required in a conventional illumination lamp, to do without additional metal parts and the conductive wire soldering process, to reduce the number of illumination lamp components, to simplify the manufacturing process, and to lower production costs as compared with those of the conventional illumination lamps.

According to the above, the foregoing embodiments of the present invention are indeed capable of the desired functions and attaining the intended objectives. Moreover, the present invention has been disclosed in such detail that a person skilled in the art can implement the invention according to the teachings provided herein. It is understood, however, that the embodiments described above serve illustrative purposes only. All equivalent structural variations and similar modifications which do not depart from the spirit of the present invention should fall within the scope of the present invention.

What is claimed is:

1. An illumination lamp, comprising:
a lamp base integrally formed of a ceramic material, the lamp base having a surface laid with a control circuit and at least one light-emitting diode (LED) element;
a lampshade covering each said LED element on the surface of the lamp base; and
electrical contacts extending respectively and integrally from two ends of the lamp base, each said electrical contact having a front end formed as a halved cone;
wherein the control circuit laid on the surface of the lamp base is formed on the surface of the lamp base by sintering silver at a high temperature and thereby chemically bonding the silver to the ceramic material, and the control circuit also covers an external portion of the electrical contact at each of the two ends of the lamp base such that the electrical contacts are in electrical conduction with the control circuit and the at least one LED element on the surface of the lamp base.

2. The illumination lamp of claim 1, wherein the lamp base has a plurality of surfaces, and the control circuit is laid on each said surface.

3. The illumination lamp of claim 1, wherein the front end of each said electrical contact is formed as a perpendicular plane.

4. The illumination lamp of claim 1, wherein the front end of each said electrical contact is formed as a curved projection.
